(19) United States
(12) Patent Application Publication
(10) Pub. No.: US 2013/0159602 A1
(43) Pub. Date: Jun. 20, 2013

(54) UNIFIED MEMORY ARCHITECTURE

(71) Applicants: Michael G. Adams, Endwell, NY (US); Andrew W. Berner, Endicott, NY (US); Mark R. Petrie, Vestal, NY (US); Dino A. Gianisis, Binghamton, NY (US); Andrew F. MacHaffie, Endicott, NY (US); James J. Ligas, Binghamton, NY (US)

(72) Inventors: Michael G. Adams, Endwell, NY (US); Andrew W. Berner, Endicott, NY (US); Mark R. Petrie, Vestal, NY (US); Dino A. Gianisis, Binghamton, NY (US); Andrew F. MacHaffie, Endicott, NY (US); James J. Ligas, Binghamton, NY (US)

(73) Assignee: BAE SYSTEMS CONTROLS, INC., Johnson City, NY (US)

(21) Appl. No.: 13/331,289

(22) Filed: Dec. 20, 2011

(51) Int. Cl. G06F 12/00

(52) U.S. Cl. 711/103; 711/101; 711/104; 711/E12.001

(57) ABSTRACT

Various embodiments of the present invention relate to a Unified Memory Architecture. The Unified Memory Architecture may use MRAM, phase change memory, and/or any other storage having similar features.

### BACKGROUND OF THE INVENTION

1. Field of the Invention

Various embodiments of the present invention relate to a Unified Memory Architecture (sometimes referred to herein as “UMA”).

A Unified Memory Architecture may use magnetoresistive random access memory (“MRAM”), phase change memory, and/or any other storage having similar features.

In various embodiments of the present invention a Unified Memory Architecture utilizes a single bank of physical memory devices (e.g., MRAM, phase change memory, and/or any other storage having similar features) to host multiple memory spaces within a CPU design. In one example, a Unified Memory Architecture design utilizes a single bank of memory that can provide the same capabilities typically provided by conventional program memory (“PROM”), conventional scratchpad or random access memory (“RAM”), and conventional non-volatile memory (“NVM”) devices.

2. Description of Related Art

Conventional CPU designs typically require the use of multiple memory banks and technologies (typically at least three different memory types) to implement: PROM, RAM, and NVM.

As used in the context of the present application, “RAM” memory may include static RAM (“SRAM”). Further, as used in the context of the present application, “NVM” or non-volatile memory may include non-volatile RAM (“NovRAM”), electrically erasable programmable read only memory (“EEPROM”) and Flash memory (“FLASH”). Further still, as used in the context of the present application, FLASH may include “Flash PROM”, “NAND FLASH” and “NOR FLASH”.

Table 1, below, identifies a number of characteristics typically associated with various conventional memory technologies.

TABLE 1

| | | Memory | Data | | Store Cycle |
|---|---|---|---|---|---|
| Memory | # of Write | Speed | Retention | Storage cycle | Speed |
| Technology | Cycles | (nSec) | (years) | approach | (mSec) |
| EEPROM | 100,000- | ≧70 | 5-10 | Can alter single location | 5 (per block) |
| | 1,000,000 | | | after unlock sequence | |
| FLASH | 10,000- | ≧95 | 10-20 | Erase sector, program | 0.24 per block |
| | 100,00 | | | location after unlock | after 3500 |
| | | | | sequence | erase |
| NovRAM | 10,000- | ≧35 | 10-20 | Initiate automated store | 10 (whole |
| | 1,000,000 | | | sequence after store | device) |
| | | | | sequence performed | |
| SRAM | Unlimited | ≧10 | 0 (no | n/a | n/a |
| | | | storage) | | |

Referring now to FIG. 1, a block diagram of a portion of a conventional system including a CPU is shown. As seen, an Address & Data Bus (e.g., a standard demultiplexed address & data bus) provides for front side bus communication among the various components. In particular, Processor 119 is provided, along with Memory Controller 117. In addition, the following memories are provided: FLASH Memory 115 (in one example, this may function as Program Memory); SRAM Memory 113; FLASH Memory 123 (in one example, this may function as Boot Memory); and NVM Memory (or Non-volatile Memory) 127. Further, CPU Bridge 101 (which may communicate with a Back Side Bus) is also provided.

### SUMMARY OF THE INVENTION

In various embodiments of the present invention a Unified Memory Architecture utilizes a single bank of physical memory devices to host multiple memory spaces within a CPU design. In one example, a Unified Memory Architecture design utilizes a single bank of memory that can provide the same capabilities typically provided by conventional PROM, RAM, and NVM devices. This architecture allows software to assign virtual banks of program memory, scratchpad RAM, and NVM that can be re-sized and/or re-allocated at any time without any physical hardware changes. Board area usage and complexity can be reduced (relative to a conventional design) due to the reduction in total part count and part types on the CPU. Reduced part types also reduce the obsolescence risk of the design.

The magnetoresistive RAM (“MRAM”) device is one technology that supports the implementation of a Unified Memory Architecture. MRAM can be easily and quickly written and read like a typical RAM device, but it also retains its contents when power is removed. This gives MRAM the capability of being used in place of a PROM, RAM, and/or NVM device. In the case of the Unified Memory Architecture, MRAM is used to substitute for and emulate any one, two or three of these device types. MRAM technology is also inherently resistant to Single Event Upsets (SEUs). SEUs are a significant concern for flight or safety critical systems. The Unified Memory Architecture could also be implemented with any other memory technology that has the ability to perform like PROM, RAM, and/or NVM devices.

Table 2, below, identifies a number of characteristics typically associated with MRAM (the characteristics enumerated are the same characteristics enumerated in Table 1, above).

TABLE 2

| | | Memory | Data | | Store Cycle |
|---|---|---|---|---|---|
| Memory | # of Write | Speed | Retention | Storage cycle | Speed |
| Technology | Cycles | (nSec) | (years) | approach | (mSec) |
| MRAM | Unlimited | <35 | 20+ | None—data is always | 0.000035 |
| | | | | “stored” after it is written | (write cycle |
| | | | | | speed per |
| | | | | | byte) |

The Unified Memory Architecture may also include the capability to partition and protect areas of the memory space under hardware control that is configured by software. This feature allows software to assign areas of the Unified Memory Architecture as read only to prevent inadvertent writes to areas that are expected to remain constant (such as, e.g., program memory). The partitioning feature also supports the use of mixed-criticality software in safety critical systems such as aircraft controls.

In one embodiment, a system for providing memory emulation comprises: a memory element selected from the group consisting of: (a) magnetoresistive random access memory; and (b) phase change memory; and a memory controller in operative communication with the memory element. In this embodiment, the memory controller is configured to partition the memory element to include at least a first memory space and a second memory space, the memory controller is configured to cause the first memory space to emulate a volatile memory, the memory controller is configured to cause the second memory space to emulate a non-volatile memory, and the emulation of the non-volatile memory requires multiple sequential unique writes to perform a memory-related operation.

In another embodiment, a method for providing memory emulation with a memory element is provided. In this embodiment the method comprises: partitioning the memory element to include at least a first memory space and a second memory space; emulating, with the first memory space, a volatile memory; and emulating, with the second memory space, a non-volatile memory; wherein the memory element is selected from the group consisting of: (a) magnetoresistive random access memory; and (b) phase change memory; and wherein the emulation of the non-volatile memory requires multiple sequential unique writes to perform a memory-related operation.

In another embodiment, a system for providing memory emulation is provided, comprising: a memory element selected from the group consisting of: (a) magnetoresistive random access memory; and (b) phase change memory; and a memory controller in operative communication with the memory element. In this embodiment the memory controller is configured to partition the memory element to include at least a first memory space, a second memory space, and a third memory space, the memory controller is configured to cause the first memory space to emulate, at an initial time, a PROM configured for read-only access, the memory controller is configured to cause the second memory space to emulate, at the initial time, a non-volatile memory configured for read-only access, the memory controller is configured to cause the third memory space to emulate, at the initial time, a RAM configured for read/write access, and the emulation of the non-volatile memory requires multiple sequential unique writes to perform a memory-related operation.

In another embodiment, emulation of the non-volatile memory allows (rather than requires) multiple sequential unique writes to perform a memory-related operation.

In another embodiment, emulation of the non-volatile memory comprises multiple sequential unique writes to perform a memory-related operation.

### BRIEF DESCRIPTION OF THE DRAWINGS

The drawings are provided for illustrative purpose only and do not necessarily represent practical examples of the present invention to scale. In the figures, same reference signs are used to denote the same or like parts.

FIG. 1 is a block diagram of a portion of a conventional system including a CPU;

FIG. 2 is a block diagram of a portion of a system including a CPU according to an embodiment of the present invention; and

FIG. 3 is a block diagram of a number of example memory maps according to embodiments of the present invention.

### DETAILED DESCRIPTION OF THE INVENTION

For the purposes of describing and claiming the present invention, the term “phase change memory” is intended to refer to any of: PCME, PRAM, PCRAM, Ovonic Unified Memory, Chalcogenide RAM or C-RAM.

For the purposes of describing and claiming the present invention, the term “a memory element” or “the memory element” is intended to refer to a single physical memory device or a plurality of physical memory devices (e.g., a memory “bank”).

For the purposes of describing and claiming the present invention, the term “a memory space” or “the memory space” is intended to refer to a range of memory addresses (e.g., a plurality of contiguous memory addresses or a plurality of non-contiguous memory addresses).

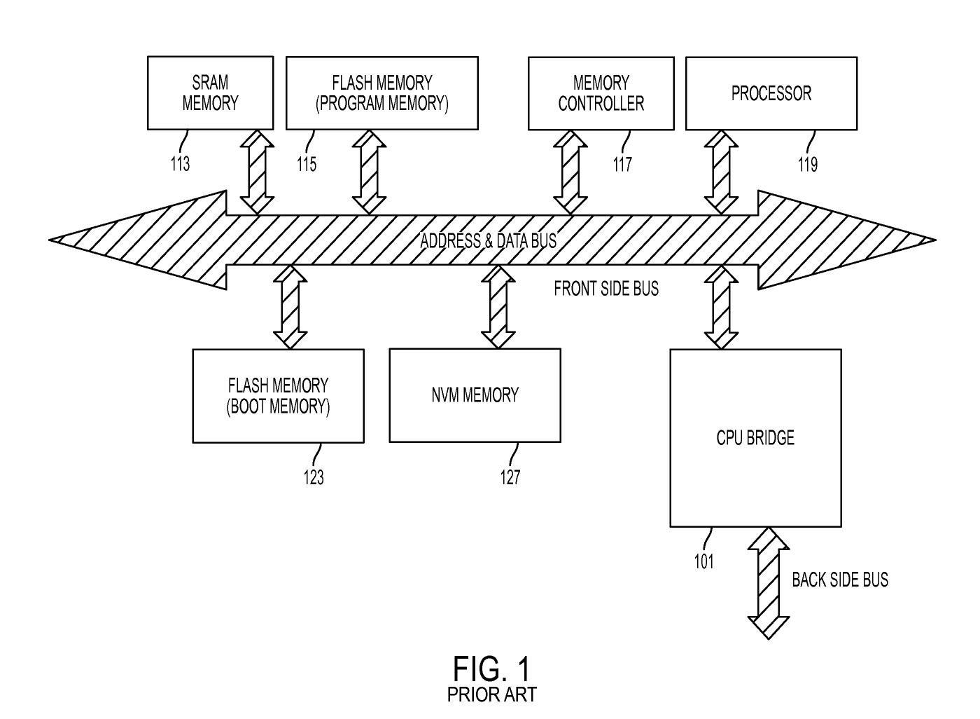

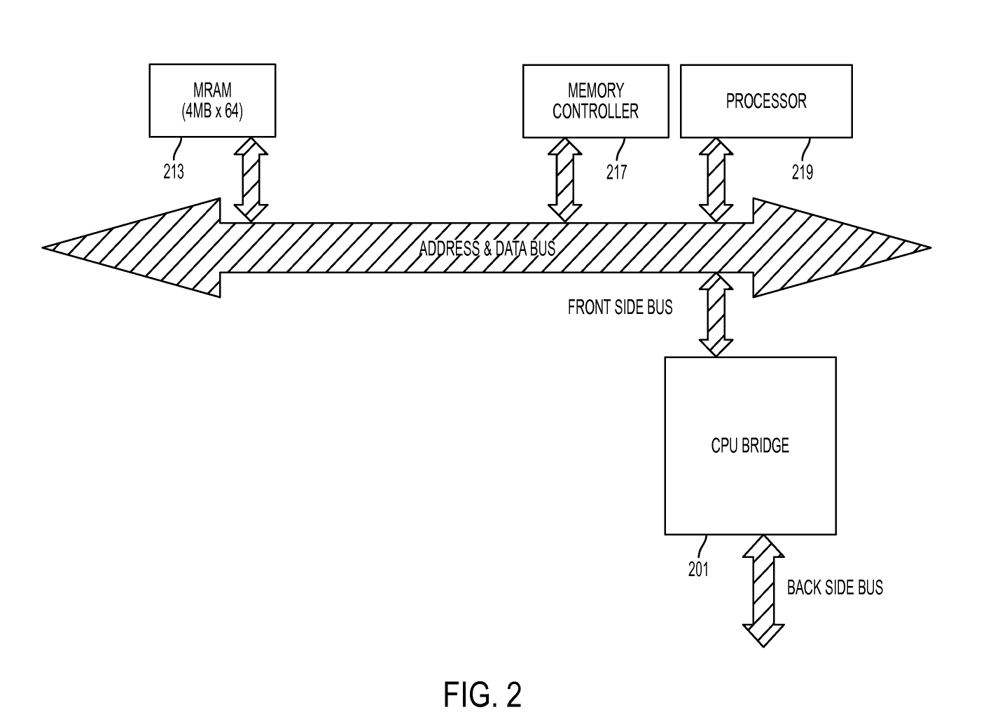

Referring now to FIG. 2, a block diagram of a portion of a system including a CPU according to an embodiment of the present invention is shown. This embodiment utilizes some of the same elements of the conventional block diagram shown in FIG. 1. An important difference, however, is that many of the memory components of the conventional block diagram of FIG. 1 are not used in the embodiment of FIG. 2, which instead uses an MRAM memory element to emulate other memory. This is described in more detail below.

Still referring to FIG. 2, an Address & Data Bus (e.g., a standard demultiplexed address & data bus) provides for front side bus communication among the various components. In particular, Processor 219 is provided, along with Memory Controller 217. In addition, MRAM 213 is provided. In one specific example, MRAM 213 may be a 4 MB×64 MRAM. Further, CPU Bridge 201 (which may communicate with a Back Side Bus) is also provided.

By utilizing the MRAM 213 to emulate the memory components shown in FIG. 1, but not used in FIG. 2, various embodiments of the present invention provide certain advantages. One advantage is the provision of flexible re-configurable memory spaces of variable size (as compared to, for example, inflexible fixed size memories of FIG. 1 due to use of specific memory device types). Another advantage is reduced board area and/or parts count and/or complexity (as compared, for example, to the board area and parts count and complexity required for the specific multiple memory device types of FIG. 1). Another advantage is use of a single memory device type (as compared, for example, to the multiple memory device types such as PROM, RAM, NovRAM in the design of FIG. 1). Another advantage is lower obsolescence risk (as compared, for example, to the higher obsolescence risk associated with the specific multiple memory device types of FIG. 1). Another advantage is no (or reduced) multiple part specific write algorithms required (as compared, for example, to the multiple part specific write algorithms for the various memory types of FIG. 1). Another advantage is faster write times for program memory (PROM) and NVM (e.g., NovRAM) (as compared, for example, to the slower write times for program memory and NVM of FIG. 1). Another advantage is no (or reduced) SEU susceptibility in RAM devices due to use, for example, of SEU resistant MRAM (as compared, for example, to the SEU susceptibility in the conventional RAM devices of FIG. 1).

As described herein, a Unified Memory Architecture according to various embodiments of the present invention provides an integrated hardware and software approach to system memory. In one example, the Unified Memory Architecture may use a single bank of MRAM or similar technology devices to implement all memory types needed in a CPU design. In another example, the system utilizes no conventional PROM, no conventional SRAM and no conventional NVM—just MRAM (or equivalent like PRAM).

In this regard, high speed (e.g., <35 nsec) non-volatile memories can act like FLASH, EEPROM, SRAM and/or NovRAM with a single device. In two specific examples, magnetoresistive memory (MRAM) and Phase Change Random Access Memory (PRAM) can be utilized. In another example, the use of MRAM and/or PRAM provides the capability to retain RAM values when power is removed.

To implement a Universal Memory Architecture according to one example the system must define and protect the different memory spaces (e.g., during power up & normal operation). A Universal Memory Architecture controller may provide default memory management chip (“MMU”) like memory space definitions in an external Memory Controller.

In one example, the Power up state of the Universal Memory Architecture may be pre-defined in a Memory Controller as follows: (a) address range 0=boot memory (read only @ power up); (b) address range 1=emulated NVM (read only @ power up); and (c) Address range 2=SRAM (read/write @ power up).

The Universal Memory Architecture approach provides flexibility in the definition of the Universal Memory Architecture memory map (e.g., what area is PROM-like, SRAM-like and NVM-like).

The Universal Memory Architecture controller may allow modification of address range definitions if power up self check is successful. In one example, address range modification will be a set of “one time write” registers. In another example, once modified it cannot be modified again without a power on reset (there may be no need to allow continuous modification of the address range registers—this makes the system more robust).

In another example, a Universal Memory Architecture controller may utilize programmable sub decoding for multiple separate memory spaces (e.g., to support software requirements/features).

In another example, a Universal Memory Architecture controller may utilize base registers (BR) similar to those used in the MPC55xx and MPC55X microcontrollers.

In another example, a Universal Memory Architecture controller may utilize definable base address and block size (this may allow the flexible memory partitioning that is desired with the UMA approach). In one specific example, the default SRAM space cannot be moved, but it can grow larger—this is because SRAM is typically needed as processor stack and for other needs almost immediately after reset (before a “Memory Map Lockout” is cleared).

In another example, a Universal Memory Architecture controller may fully implement a “Memory Map” Lockout feature, wherein: (a) a remapping of memory when a lockout discrete is cleared is enabled; (b) these discretes may come from a general purpose IO discrete (GPIO) or some similar discrete interlock signal; (c) once the “Memory Map Lockout” is cleared (in one example this would be after the MMU is active) the entire memory space is read/write “R/W” (expect for the “PROM” space—see below) and is controlled by the MMU.

In another example, a Universal Memory Architecture controller may utilize a write pattern lockout for the “PROM” area of MRAM (just like in conventional FLASH PROMs). In one specific example, this may be similar to the Write unlock sequence in conventional FLASH memories and this Write protect would stay unlocked longer (e.g., 5-10 milliseconds) and not limit the number of writes allowed while the Write protect is cleared.

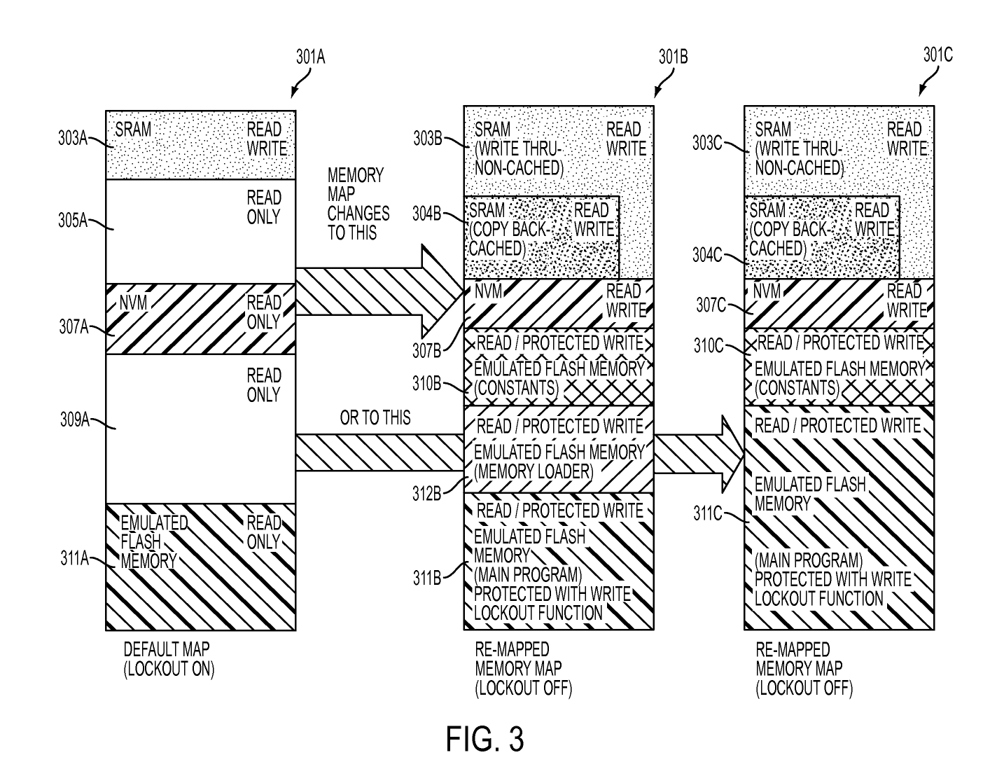

Referring now to FIG. 3, it is seen that what is shown are three example memory maps—memory map 301A, memory map 301B and memory map 301C. More particularly, Memory map 301A shows a default memory map (with lockout on), memory map 301B shows one re-mapped memory map (with lockout off), and memory map 301C shows another re-mapped memory map (with lockout off). Of note, each of these memory maps refers to emulation, using a physical MRAM or PRAM device, of the enumerated types of memories shown in FIG. 3.

Referring now in particular to example memory map 301A, it is seen that the underlying physical MRAM or PRAM device has a number of memory spaces—memory space 303A, memory space 305A, memory space 307A, memory space 309A, and memory space 311A. Further, each of the memory spaces is used to emulate a particular type of memory as follows: (a) memory space 303A—SRAM type memory (e.g., in a Read/Write mode); (b) memory space 305A—Read-only type memory; (c) memory space 307A—NVM type memory (e.g., in a Read-only mode); (d) memory space 309A—Read-only type memory; and (e) memory space 311A—FLASH (PROM) type memory (e.g., in a Read-only mode).

Referring now in particular to example memory map 301B, it is seen that the underlying physical MRAM or PRAM device has a number of memory spaces—memory space 303B, memory space 304B, memory space 307B, memory space 310B, memory space 311B, and memory space 312B. Further, each of the memory spaces is used to emulate a particular type of memory as follows: (a) memory space 303B—SRAM type memory (e.g., Write Thru non-cached in a Read/Write mode); (b) memory space 304B—SRAM type memory (e.g., Copy Back cached in a Read/Write mode); (c) memory space 307B—NVM type memory (e.g., in a Read/Write mode); (d) memory space 310B—FLASH (PROM) type memory (e.g., in a Read/Protected Write mode); (e) memory space 312B—FLASH (PROM) type memory (e.g., in a Read/Protected Write mode); and (f) memory space 311B—FLASH (PROM) type memory (e.g., for a main program, protected with a Write Lockout function, in a Read/Protected Write mode).

Referring now in particular to example memory map 301C, it is seen that the underlying physical MRAM or PRAM device has a number of memory spaces—memory space 303C, memory space 304C, memory space 307C, memory space 311C, and memory space 310C. Further, each of the memory spaces is used to emulate a particular type of memory as follows: (a) memory space 303C—SRAM type memory (e.g., Write Thru non-cached in a Read/Write mode); (b) memory space 304C—SRAM type memory (e.g., Copy Back cached in a Read/Write mode); (c) memory space 307C—NVM type memory (e.g., in a Read/Write mode); (d) memory space 310C—FLASH (PROM) type memory (e.g., in a Read/Protected Write mode); and (e) memory space 311C—FLASH (PROM) type memory (e.g., for a main program, protected with a Write Lockout function, in a Read/Protected Write mode).

In one example, a PROM Constants region (see, e.g., 310B, 310C) is an example of a partitioned PROM region under the UMA. Such a region may contain non-executable program data such as configuration tables to be used by the executable code in another region or system identification information.

In another example, a partitioned PROM region may be a generic Memory Loader (see, e.g., 312B). In a specific example, the Memory Loader may be an Aircraft Memory Loader (a specific SW (software) function that requires a dedicated PROM region).

In another example, a Write Lockout function (see, e.g., 311B, 311C) may be generally similar to a Read/Protected Write (see, e.g., 310B, 310C, 312B) but may differ with regard to the degree and type of write protection and may vary, for example, based upon system needs. In one specific example, some regions may require additional interlocks to allow writes.

In another example, EEPROM and FLASH have slightly different programming algorithms. FLASH PROMS are typically organized in relatively large sectors (e.g., 64 Kb per sector). The sectors each typically have to be erased before being written. EEPROMS typically contain relatively small “pages” (e.g., 32 bytes) that can be programmed without erasing them first. After each page is written, software must wait for the device to complete an internal page store process before moving on to the next page write. EEPROMs typically also include an unlock code that must be written prior to allowing writes to the device.

Of note, the same underlying physical MRAM or PRAM device is used for each of the memory mappings and emulations shown in FIG. 3. Thus, embodiments of the present invention provide a single hardware design that can be used to host different applications requiring different memory mappings and emulations.

As described herein, the Universal Memory Architecture approach allows the system to emulate hardware features of various other memory technologies that are not conventional present in the underlying memory technologies, such as MRAM. Table 3 below (related to FLASH) and Table 4 below (related to other NVM's) identify some examples of the features emulated by the UMA approach:

TABLE 3
FLASH memories—These memories require software interlock procedures
that unlock hardware functional protections like:

| MEMORY OPERATION | PROCEDURE |
|---|---|
| Program | Requires multiple sequential unique writes to |
| | allow a location to be programmed |
| Write to buffer | Requires multiple sequential unique writes to |
| | allow a block to be programmed |
| Sector erase | Requires multiple sequential unique writes to |
| | allow a sector to be erased |
| Chip erase | Requires multiple sequential unique writes to |
| | allow a chip to be erased |

TABLE 4
Other non-volatile memories—These memories require software
interlock procedures to perform hardware store and recalls:

| MEMORY OPERATION | PROCEDURE |
|---|---|
| Store | Requires multiple sequential unique writes to |
| | initiate Store operation (which is a block backup |
| | of the device to a location that can't be directly |
| | accessed performed by hardware). |
| Recall | Requires multiple sequential unique writes to |
| | initiate Recall operation (which is a block recall |
| | from a non-addressable location to an addressable |
| | memory block performed by hardware). |

Of note, the reasons that these features may need to be emulated are varied. In some systems it is desirable to protect stored data or program code from getting corrupted by inadvertent writes. For example these inadvertent writes may be from a software error, or a power down hardware glitch. Memories like MRAM could get their contents corrupted without these protections (that typically exist in conventional devices like FLASH and NVM memories).

As described herein, various embodiments of the present invention may make an MRAM, phase change memory, and/or any other storage having similar features (e.g., high speed read/write non-volatile memory) look (to an associated system) like one or more conventional PROM devices, one or more conventional RAM devices and/or one or more conventional NVM devices.

In other examples, the present invention may be applied to commercial use and/or to military use.

In other examples, the present invention may be applied in the context of avionics use (e.g., aircraft controls) and the like.

In another example, the address & data bus may be a 60x bus.

In other examples, any steps described herein may be carried out in any appropriate desired order.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects. Furthermore, aspects of the present invention may take the form of a computer program product embodied in one or more computer readable medium(s) having computer readable program code embodied thereon. In one example, the computer readable medium may tangibly embody the program code in a non-transitory manner.

Computer program code for carrying out operations for aspects of the present invention may be written in any desired language or in any combination of one or more programming languages, including (but not limited to) an object oriented programming language such as Java, Smalltalk, C++ or the like or a procedural programming language, such as the “C” programming language or similar programming languages.

Aspects of the present invention are described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Further, these computer program instructions may be stored in a computer readable medium that can direct a computer, other programmable data processing apparatus, or other device(s) to function in a particular manner, such that the instructions stored in the computer readable medium produce an article of manufacture including instructions which implement the function/act specified in the flowchart and/or block diagram block or blocks.

Further, these computer program instructions may be loaded onto a computer, other programmable data processing apparatus, or other device(s) to cause a series of operational steps to be performed on the computer, other programmable apparatus or other device(s) to produce a computer implemented process such that the instructions which execute on the computer or other programmable apparatus or other device(s) provide processes for implementing the functions/acts specified in the flowchart and/or block diagram block or blocks.

The flowcharts and/or block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the function(s) noted in the block may occur out of the order noted in the figures. For example, two blocks shown in succession may, in fact, be executed substantially concurrently, or the blocks may sometimes be executed in the reverse order, depending upon the functionality involved.

It is noted that the foregoing has outlined some of the embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. Further, it is noted that all examples disclosed herein are intended to be illustrative, and not restrictive.

What is claimed is:

1. A system for providing memory emulation, comprising:
a memory element selected from the group consisting of: (a) magnetoresistive random access memory; and (b) phase change memory; and
a memory controller in operative communication with the memory element,
the memory controller being configured to partition the memory element to include at least a first memory space and a second memory space,
the memory controller being configured to cause the first memory space to emulate a volatile memory,
the memory controller being configured to cause the second memory space to emulate a non-volatile memory, and
the emulation of the non-volatile memory requiring multiple sequential unique writes to perform a memory-related operation.

2. The system of claim 1, wherein the emulated volatile memory is selected from the group comprising: (a) PROM; and (b) RAM.

3. The system of claim 1, wherein the emulated non-volatile memory is FLASH and the memory operation is selected from the group comprising: (a) a program operation; (b) a write to buffer operation; (c) a sector erase operation; and (d) chip erase operation.

4. The system of claim 1, wherein the emulated non-volatile memory is EEPROM and the memory operation is selected from the group comprising: (a) a program operation; and (b) a write to buffer operation.

5. The system of claim 1, wherein the emulated non-volatile memory is NovRAM and the memory operation is selected from the group comprising: (a) a store operation; and (b) a recall operation.

6. The system of claim 1, wherein:
the memory controller is configured to cause the first memory space to emulate PROM;
the memory controller is configured to partition the memory element to further include at least a third memory space; and
the memory controller is configured to cause the third memory space to emulate RAM.

7. The system of claim 1, wherein the memory element comprises a single physical device.

8. The system of claim 1, wherein the memory element comprises a plurality of physical devices.

9. The system of claim 8, wherein the first memory space is on a first one of the plurality of physical devices and the second memory space is on a second one of the plurality of physical devices.

10. The system of claim 1, wherein the memory controller is in operative communication with the memory element via use of a bus.

11. The system of claim 1, wherein the system further comprises a central processing unit and the memory controller is in operative communication with the central processing unit.

12. The system of claim 1, wherein the system further comprises a central processing unit and the memory controller is integrated with the central processing unit.

13. The system of claim 1, wherein the memory element is magnetoresistive random access memory.

14. The system of claim 1, wherein the memory element is phase change memory.

15. A method for providing memory emulation with a memory element, comprising:
partitioning the memory element to include at least a first memory space and a second memory space;
emulating, with the first memory space, a volatile memory; and
emulating, with the second memory space, a non-volatile memory;
wherein the memory element is selected from the group consisting of: (a) magnetoresistive random access memory; and (b) phase change memory; and
wherein the emulation of the non-volatile memory requires multiple sequential unique writes to perform a memory-related operation.

16. The method of claim 15, wherein the emulated volatile memory is selected from the group comprising: (a) PROM; and (b) RAM.

17. The method of claim 15, wherein the emulated non-volatile memory is FLASH and the memory operation is selected from the group comprising: (a) a program operation; (b) a write to buffer operation; (c) a sector erase operation; and (d) chip erase operation.

18. The method of claim 15, wherein the emulated non-volatile memory is EEPROM and the memory operation is selected from the group comprising: (a) a program operation; and (b) a write to buffer operation.

19. The method of claim 15, wherein the emulated non-volatile memory is NovRAM and the memory operation is selected from the group comprising: (a) a store operation; and (b) a recall operation.

20. The method of claim 15, further comprising partitioning the memory element to include at least the first memory space, the second memory space, and a third memory space; wherein the first memory space emulates PROM; and wherein the third memory space emulates RAM.

21. The method of claim 15, wherein:
the first memory space has associated therewith, at an initial time, an initial base address and an initial block size;
the second memory space has associated therewith, at the initial time, an initial base address and an initial block size;
at least one of the first and second memory spaces is remapped, at a time subsequent to the initial time, to have a remapped block size; and
the remapped block size is distinct from the initial block size of the respective memory space.

22. The method of claim 21, wherein the first memory space is remapped, at a time subsequent to the initial time, to have a remapped block size and the second memory space is remapped, at a time subsequent to the initial time, to have a remapped block size.

23. The method of claim 15, wherein:
the first memory space has associated therewith, at an initial time, an initial base address and an initial size;
the second memory space has associated therewith, at the initial time, an initial base address and an initial size;
at least one of the first and second memory spaces is remapped, at a time subsequent to the initial time, to have a remapped base address; and
the remapped base address is distinct from the initial base address of the respective memory space.

24. The method of claim 23, wherein the first memory space is remapped, at a time subsequent to the initial time, to have a remapped base address and the second memory space is remapped, at a time subsequent to the initial time, to have a remapped base address.

25. The method of claim 15, wherein the memory element is magnetoresistive random access memory.

26. The method of claim 15, wherein the memory element is phase change memory.

27. The method of claim 15, wherein the steps are carried out in the order recited.

28. A system for providing memory emulation, comprising:
a memory element selected from the group consisting of: (a) magnetoresistive random access memory; and (b) phase change memory; and
a memory controller in operative communication with the memory element,
the memory controller being configured to partition the memory element to include at least a first memory space, a second memory space, and a third memory space,
the memory controller being configured to cause the first memory space to emulate, at an initial time, a PROM configured for read-only access,
the memory controller being configured to cause the second memory space to emulate, at the initial time, a non-volatile memory configured for read-only access,
the memory controller being configured to cause the third memory space to emulate, at the initial time, a RAM configured for read/write access, and
the emulation of the non-volatile memory requiring multiple sequential unique writes to perform a memory-related operation.

29. The system of claim 28, wherein the emulated volatile memory is selected from the group comprising: (a) PROM; and (b) RAM.

30. The system of claim 28, wherein the emulated non-volatile memory is FLASH and the memory operation is selected from the group comprising: (a) a program operation; (b) a write to buffer operation; (c) a sector erase operation; and (d) chip erase operation.

31. The system of claim 28, wherein the emulated non-volatile memory is EEPROM and the memory operation is selected from the group comprising: (a) a program operation; and (b) a write to buffer operation.

32. The system of claim 28, wherein the emulated non-volatile memory is NovRAM and the memory operation is selected from the group comprising: (a) a store operation; and (b) a recall operation.

33. The system of claim 28, wherein the initial time is a time of a power-up of the system.

34. The system of claim 33, wherein at a time subsequent to the initial time at least one of:
a base address of the first memory space is changed;
a base address of the second memory space is changed;
a base address of the third memory space is changed;
a block size of the first memory space is changed;
a block size of the second memory space is changed; and
a block size of the third memory space is changed.

35. The system of claim 28, wherein the memory element is magnetoresistive random access memory.

36. The system of claim 28, wherein the memory element is phase change memory.
